(19) United States
(12) Patent Application Publication
(10) Pub. No.: US 2009/0251285 A1
(43) Pub. Date: Oct. 8, 2009

(54) USING PHYSICAL OBJECTS TO CONTROL ENABLEMENT/DISABLEMENT OF DEVICE FUNCTIONALITY

(75) Inventors: LYDIA M. DO, RALEIGH, NC (US); PAMELA A. NESBITT, TAMPA, FL (US); LISA A. SEACAT, SAN FRANCISCO, CA (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/098,591

(22) Filed: Apr. 7, 2008

(51) Int. Cl. G05B 19/402

(52) U.S. Cl. 340/5.74

(57) ABSTRACT

At least one N-sided physical object proximate to a computing device can be detected. Each side of the N-sided physical object can be associated with at least one enablement state for a functionality of the computing device. A side of the N-sided object that faces a reference plane can be sensed. An enablement state of a functionality of at least one computing device can be programmatically changed to correspond to an enablement state indicated by the N-sided physical object.

### BACKGROUND OF THE INVENTION

The present invention relates to the field of computing devices, and, more particularly, to using a physical object, it's positioning, and its proximity to a computing device to control enablement/disablement of device functionality.

Often enabling/disabling functionality of a computing device requires authentication information as input that verifies a user has appropriate authority. This input can include a number sequence (e.g., a PIN number or access code), a password, a biometric input, etc. Generally, more secure measures impose a correspondingly greater cost in hardware and/or user inconvenience than lower security measures. Inputting complex and/or long authentication codes can be especially cumbersome for computing devices having limited peripherals, such as mobile devices.

The situation regarding security and/or enablement for computing devices is further complicated by interactive situations, for situations involving device etiquette, and for shared computing spaces. In these situations, it is often easy for a device user to inadvertently fail to change a state of their device to one appropriate for a situation. For example, it is easy for a mobile phone user to forget to disable overt ring tones during a meeting, which results in one or more mobile phones ringing during a course of the meeting, disrupting everyone and often having socially or business negative consequences for a device owner. In other situations, individual uses of otherwise helpful technology can be distracting overall, due in part to a lack of centralized control over these individual devices. For example, in a lecture situation, a presenter generally doesn't have control of computing devices of lecture attendees.

In still another situation, one or more computing machines can exist that are designed to be utilized by multiple different users, often for either a limited period of time or for a fee. For example, many public computers are supposed to be used for ten minutes or less, to ensure that one user does not dominate the use of the computer. In an internet cafe example, computing devices can be publicly used for a fee, where paying a fee typically results in being provided an access code permitting a device's use for a period of time.

In all of the above situations, it is beneficial for device functionality to be selectively enabled/disabled based upon a set of deterministic conditions. Existing solutions exist and are diverse and vary in complexity and technological focus. For example, many “blocking” technologies have been contemplated for selectively turning off a device's ability to access a network within a limited zone. Some of these blocking technologies purposefully interfere or selectively shield a frequency band, which is problematic from a Federal Communication Commission (FCC) perspective. Many enablement technologies, such as strong password use, are very cumbersome to users. Still other technologies are user/situation specific. A vast majority of these technologies require complex user or administrator configurations and are non-intuitive for a vast majority of users, which has greatly hampered their acceptance.

Additionally, traditional technologies involving security and access objects (e.g., use of RFID badge to gain access to a system or area) are used in a binary fashion to turn a device on/off or to gain/prevent access. Other technologies are used conjunctively to control various computing device functions. For example, granting/denying computer access and determining an access level general requires a user to log into a machine and to provide a password. No known system makes use of physical object, which can not only be used to permit access to otherwise secure devices, but which can also be manipulated by a user to change configuration options of the device.

### BRIEF SUMMARY OF THE INVENTION

One aspect of the present invention can include a method, apparatus, computer program product, and system for controlling the enablement state of a functionality of a computing device. In the method, at least one N-sided physical object placed nearby can be detected. Each side of the N-sided physical object can be associated with at least one enablement state for a functionality of a computing device. A side of the N-sided object that faces a reference plane can be sensed. An enablement state of a functionality of the computing device can be programmatically changed to correspond to an enablement state indicated by the N-sided physical object. A user can adjust this state dynamically by repositioning the N-sided object.

Another aspect of the present invention can include a computing device that includes an object detector and an enablement engine. The object detector can detect a presence and a position of at least one physical object proximate to a computing device. Different positions of the physical object can correspond to different enablement states for at least one functionality of the computing device. The enablement engine can control an enablement state of functionality of the computing device. The enablement state can include at least an active state and an inactive state. The enablement engine can detect a change in positioning of the physical object and can perform programmatic actions to modify the enablement state of the functionality to correspond to an enablement state indicated by the change in positioning of the physical object.

Still another aspect of the present invention can include a physical object for controlling an enablement state of a functionality of a computing device. The physical object can include at least one unique characteristic that is configured to be detected by a computing device not directly electronically coupled to the physical object when the physical token is placed on a surface proximate to the computing device. A positioning of the physical token relative to the surface can correspond to different enablement states for the functionality.

### BRIEF DESCRIPTION OF THE SEVERAL VIEWS OF THE DRAWINGS

FIG. 1 is a schematic diagram illustrating a system that uses a physical object to enable/disable a functionality of a computing device in accordance with embodiments of the inventive arrangements disclosed herein.

FIG. 2 is a collection of sample embodiments for a physical object that controls an enablement/disablement of a computing device functionality in accordance with an embodiment of the inventive arrangements disclosed herein

FIG. 3 is a flow chart of a method detailing the use of a physical object to control an enablement state of a computing device in accordance with an embodiment of the inventive arrangements disclosed herein.

### DETAILED DESCRIPTION OF THE INVENTION

The present invention discloses a solution that uses a physical object as a means for controlling the enablement/disablement of computing device functionality. The physical object can be an object that is not electronically coupled to a computing device that it influences. The object can, for example, be paired to a special surface, such as a mouse pad, where a presence or absence on this surface can represent different enablement/disablement states. For example, an internet cafe can require a distributed object be placed on a paired mouse pad before a computer is enabled. In that example, the “sensing” components can be disposed in the peripheral surface, which can be electronically coupled to the computing device. The physical object can also include a wireless transceiver (e.g., BLUETOOTH, WIFI, WIRELESS USB), and/or a detectable chip/sensor (e.g., RFID tag), which permits the computing device to detect whether the physical object is within a designated proximity of the computing device and/or which enables the computing device to determine a state/orientation/setting of the physical object. A data store can be optionally included in the physical object which can contain digitally encoded information able to be conveyed to the computing device.

In one embodiment, the physical object can have multiple sides (N-side) and/or positions (N-positions), each reflecting an enablement state for a computing device functionality. In one embodiment, for instance, a flip-able coin (physical object) can have one side representing enablement and another representing disablement. Use of such a flip-able object is not only intuitive for a user, but is also externally observable, which in public situations can be a distinct advantage over traditional enablement/disablement mechanisms that are only observable by examining a computing device itself. For example, in a meeting situation, an attendee's neighbor and/or a presenter can glance at an enablement/disablement object to determine if the attendee has disabled their mobile phone.

The invention contemplates using a single physical object to control one or more other computing devices. For example, a presenter of a meeting can have a “master” object that is able to disable/enable all other devices during a course of a meeting. In another example, a user can link multiple devices (e.g., a notebook computer, a personal data assistant, a mobile phone, etc.) to a single physical object and can automatically adjust a state/functionality of each device by changing a state of the physical object. A state of multiple physical objects can also be combined to determine an overall state for a set of one or more devices. For example, each user of a meeting can have a physical object and a state of all devices for a meeting can be based upon configurable programmatic rules driven by states of individual physical objects.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

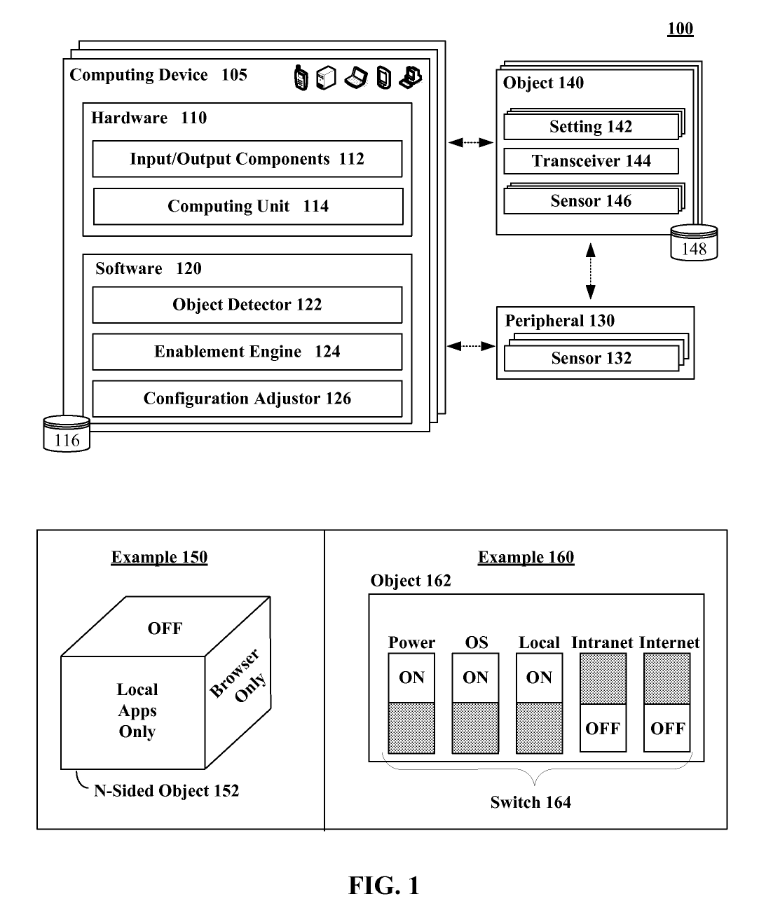

FIG. 1 is a schematic diagram illustrating a system 100 that uses a physical object 140 to enable/disable a functionality of a computing device 105 in accordance with embodiments of the inventive arrangements disclosed herein. The physical object 140 can be an object that is not physically or electronically coupled directly to the computing device 105, but which is detectable by the device 105. For example, the object 140 can be linked to device 105 via a wireless personal area network (PAN), but no physical communication lines necessarily join the object 140 and the device 105. It can be significant that no direct physical coupling is necessary as it such a coupling can substantially decrease an intuitiveness of the object's use and can limit a manner in which the object 140 can be adjusted. For example, it can be significantly harder to implement object 140 as a N-sided object, each side corresponding to a setting 142, when the object 140 must be physically connected to device 105. Detection by device 105 includes a detection of a presence/absence/proximity of the physical object 140 as well as a state of one or more settings 142 of the object 140. These settings 142 and/or a proximity of object 140 to device 105 or peripheral 130 can determine whether a functionality of device 105 is enabled or disabled.

In various implementations, a one-to-one, a one-to-many, a many-to-one, and a many-to-many relationship can exist between device 105 and object 140. That is, a single object 140 can control an enablement of functionality of a single device 140, multiple objects 140 can control an enablement of device 140 functionality, a single object 140 can control enablement of functionality for multiple devices 105, and multiple devices 150 can have their functionality controlled based upon a configuration of multiple objects 140.

In one embodiment, the physical object 140 can be coupled to a peripheral 130, which optionally includes one or more sensors 132. The peripheral 130 can be electronically coupled and/or otherwise communicatively linked to the device 105. For example, peripheral 130 can be a sensing surface (e.g. using sensors 130) able to detect a presence or absence of token 140 upon the surface. The peripheral 130 can also read a setting 142 state of the physical object 140, which it can convey to the computing device 105.

In a peripheral-less embodiment, object 140 can directly communicate with device 105 through means other than a direct electrical coupling. For example, object 140 can include a wireless transceiver 144 that is coupled to an equivalent transceiving input/output component 112 of hardware 110. Any number of wireless protocols (e.g., BLUETOOTH, WIRELESS USB, ZIGBEE, ZWAVE, etc.) can be utilized. In another implementation, object 140 can include a passive, active, or semi-active Radio Frequency Identification (RFID) component coupled to a corresponding component 112 that permits an exchange of information and/or presence detection between device 105 and object 140. The object 140 itself can include one or more sensors 146, which determine a positioning of the settings 142 and or a placement of the object 140 relative to gravity, a reference plane, or a reference point.

The enabling/disabling of device 105 functionality can refer to any of a variety of different state-changing mechanisms implemented in either hardware 110, software 120, firmware, or combinations of hardware 110, software 120 and firmware. In one implementation, for example, enabling/disabling functionality can result in a change a power-on state of device 105, can block/permit access to an input/output port or peripheral (components 112), or can grant/deny physical access to device 105. In another implementation, enabling/disabling functionality can refer to a Basic Instruction Operating System (BIOS) level lock, an Operating System (OS) level lock, a user logging level lock, an application specific lock, a file specific lock, and/or a permission of any selectively accessible computing resource of device 105. Further, the enablement/disablement of functionality can specify one of multiple granularity levels (i.e., can determine whether none, read, insert, delete, etc. privileges are granted on a file, can determine a granted application privilege level, and the like).

An object detector 122 of device 105 can determine a presence, absence, proximity, of the object 140. An enablement engine 124 can include algorithms to determine an appropriate value related to an enablement/disablement of a device 105 functionality based upon object 140 settings 142 and/or presence. Enablement engine 124 can also apply enablement/disablement settings based upon the determination. For example, engine 124 can fire a set of events, which are detected by device 110 hardware 110/software components 120 and which cause these component 110, 120 to change their enablement state. A configuration adjustor 126 can permit a user/administrator to configure the rules, settings, thresholds, algorithms, etc., controlling behavior of device 105 given a placement and/or setting 132 of object 140.

As used herein, computing device 105 can be any device having one or more functions able to be selectively enabled/disabled via object 140. Computing device 105 can be a single user device, such as a notebook, a personal computer, a mobile telephone, a navigation device, and the like. Computing device 105 can also be a device designed to be concurrently used by multiple users, such as a surface based computer, a server, and the like. On concurrent use devices 105, enablement/disablement settings can be user specific, can apply to groups of users, and/or can apply to all users.

Peripheral 130 can be any of a variety of peripherals communicatively linked to computing device 105. The peripheral 130 can be an “overloaded” device having a core functionality in addition to a capability to interact with object 140. For example, peripheral 130 can be a mouse pad having an object-sensitive surface or surface region. In another example, peripheral 130 can include a touch-sensitive surface, upon which object 140 can be placed and detected. Peripheral 130 can also be a special purpose peripheral specifically designed to be paired with object 140. For example, peripheral 130 can be a magnetic region of a device 105, which is designed to permit object 140 to be magnetically attached/detached.

Object 140 can be implemented as any physical object able to be configured/adjusted through manual manipulations. Object 140 can include a number of settings 142, which a user can manually manipulate. Different settings 142 can represent different enablement states of a given functionality. States can be established by manually manipulating one or more included switches, toggle buttons, and the like. In one embodiment, the object 140 can be an N-sided “setting,” where the object 140 can be positioned so that different sides of the N-sided object are facing a reference direction; the facing side representing a current setting 142 of the object.

The object 140 can include one or more sensors 146, which can assist in sensing a current position and/or state of the object 140. For example, one sensor 146 can be a pressure sensor which senses which side of an N-sided object 140 is downward facing. The sensor 146 can also include a gravity sensor, an accelerometer, a magnetic sensor, a light emission/detection system, and the like able to be adapted to similar purposes.

The object 140 can optionally include a data store 148, which can store digitally encoded information relating to the object 140, to the user of object 140, to a functionality controlled by object 140, and/or to one or more devices 105. For example, data store 148 can store a security key or code, which is needed to enable/disable a functionality of device 105. In another embodiment, data store 148 can include an identification key, which is applied and logged for transactions involving the computing device 105, so that user interactions can be monitored with an added assurance (in addition to a user login) that a user of device 105 is a possessor of object 140. Thus object 140 can represent an additional layer of security or identity verification over conventional technologies. In yet another embodiment, the data store 148 can be used to store sensitive information manipulated and/or shared by device 105, where different data encryptions are applied to the internally stored data. When the different settings 142 are applied, different encryption/decryption actions can occur, which change an access state of the internally stored data (e.g., read, write, update) for device 105.

In one embodiment, object 140 can also include a notifier 147, which notifies observers geographically proximate to object 140 and/or computing device 105 of the state of object 140. For example, object 140 can be an two-sided object designed to have a highly visible face (red for disabled, green for enabled) that permits even a casual observer to notice an enablement state. In another example, object 140 can communicate setting 142 information to a non-controlled devices, such as a device that presents to a lecturer the various enablement states for notebook computers used in a lecture hall.

Example 150 shows an implementing where object 140 is an N-sided object 152. Each side 154 of the N-sided object 152 can be labeled as an enablement state. A user can position the object 152 so that a desired state faces in a designated direction, such as upwards. When the N-sided object 152 is a two sided object, for example, one side can represent an enabled state and the other a disabled one. Flipping this two sided object can result in a change in enablement state. When the N-sided object 152 has more sides, such as a six sided object—or cube, each side can represent a different state. For example, when an upward facing side indicates “off” an enablement state of a corresponding device 105 can be off. Other sides of the object 152 can indicate different enablement or access states, such as “on”, hibernate, sleep, locked, browser only, local application only, limited networking for intranet only, and the like.

In one configuration, a set of different n-sided objects 152 can be used conjunctively for different enablement states of device 105. For example, a first three-sided object 152 can express whether network functionality is disabled, limited to intranet, or fully enabled. A second four sided object 152 can indicate data access privileges for a related set of data, where sides include “none”, “read”, “update”, “delete”, and “add”. Any number of objects 152 can be conjunctively used to indicate any possible set of enablement/disablement states for any possible set of functions. Use of multiple different objects 152 can be extremely useful in many settings, such as for price-differentiating computing device 105 access in a for-fee situation. For example, a user of an internet cafe can pay different rates depending upon the service(s) desired, each enabled/disabled through use of different physical objects 140.

In another example, different application use licenses can be associated with different objects 152, whose presence is required to utilize an associated license. Using an internet cafe' scenario, use of a particular “game” available through a for-fee computer can require use of an object 152. Thus, instead of paying for licenses for each game and each computer, an internet cafe' can have a lesser number of licenses, each represented by an enabling object 152. Use of enabling objects 140 can also be highly beneficial to prevent software piracy, as enablement objects 140 can be difficult to illegally replicate and distribute.

Another embodiment, shown in example 160, of object 162 includes multiple toggle-able switches. Each switch 164 can be associated with one or more functionality. Each switch can be used to toggle one or more application states. For example, different switches can enable/disable a power state, a OS access state, local application access, local intranet access, and/or internet access of an associated device 105 or set of devices 105. These examples 150, 160 are for illustrative purposes only and others are contemplated.

In one arrangement, the object 140 can represent a “master” controller for a set of devices 105, which establishes a maximum permission set for these devices. For example, a lecture room leader can use object 140 to enable/disable internet access available to each computing device in a given lecture hall. In another example, a meeting leader can use object 140 to disable in-bound call capabilities of all telephony devices using a switch of object 140.

As used herein, presented data store 116 can be a physical or virtual storage space configured to store digital information. Data store 140 can be physically implemented within any type of hardware including, but not limited to, a magnetic disk, an optical disk, a semiconductor memory, a digitally encoded plastic memory, a holographic memory, or any other recording medium. The data store 140 can be a stand-alone storage unit as well as a storage unit formed from a plurality of physical devices. Additionally, information can be stored within data store 140 in a variety of manners. For example, information can be stored within a database structure or can be stored within one or more files of a file storage system, where each file may or may not be indexed for information searching purposes. Further, data store 140 can utilize one or more encryption mechanisms to protect stored information from unauthorized access.

Use of one or more objects 140 to affect an enablement of functionality associated with one or more computing devices 105 provides an intuitive, efficient, effective, configurable, and secure solution to many problematic situations. System 100 can permit users, systems 105, applications, and functionalities to be associated with different objects 140 and object settings 142 through an arbitrarily complex arrangement of configurable functional states suitable for a given situation. Appreciation of a robustness and flexibly offered by system 100 can be illustrated through the following scenarios.

One such scenario is to use objects 140 in a corporate shareholder voting context. In this example, each shareholder can have one or more physical objects 140 that enables them to vote a specified number of shares. Voting can occur through or be confirmed by a computing device 105. When quorum is present at a given meeting (as determined by a presence/absence of physical objects 140 and associated votes) quorum specific voting options can be enabled, which are otherwise disabled. A shareholder can anonymously assign his/her voting rights to another by physically transferring a voting token to a proxy. Additionally, if voting shareholders desire, a quantity of votes in their control can remain confidential, being known only to the computing device 105 used to tally/confirm the votes. In an elaboration, a vote itself can be specified using object 140 (e.g., one side of object 140 faces up for a “YES” vote or down for “NO” vote).

Another scenario for using objects 140 can be for a test taking/classroom situation. Here, testing can be performed in a computing device 105 assisted fashion. If testing is to be limited to a specific room, that room can have a room specific object 140 associated with it that is necessary to enable testing functionality. If testing requires supervision of a proctor, that proctor can have an associated object 140 and testing functionality can only be permitted when the proctor (e.g., the object 140) is within a range (e.g., a PAN range between the object 140 and a computing device able to exchange data via a transceiver 144) specified for the test. Each test taker can require a user specific object 140, which ensures each test taker is a person who is credited for test results. In one embodiment, the object 140 can include a photograph (e.g., object 140 can be a student ID) that must be face-up and viewable by a proctor in order for test functionality to be enabled. In the test scenario, timing for taking a test can be tracked by computing device 105, which permits greater than average flexibility for a timed test than is normally permitted. For example, students may be able to take the test during a time window (five hours) greater than the test time (two hours), where a combination of object 140 presence and device 105 use ensures that the test time is not exceeded. Different tests can be administered at different times and for different student positions based again on data assisted through an object 140/device 105 relationship, which minimizes a potential of successful cheating.

As these scenarios illustrate, using a set of physical objects 140 discrete from a computing device 105 to enable/disable a functionality of a computing device 105 provides security enhancements, automatic user presence tracking and authentication, and provides a user configurable way to modify computing device settings to tailor behavior of a public use computing environment. In short, use of an object 140 as described in conjunction with computing device 105 is a paradigm shift that has broad reaching implementations for computing and which can be selectively applied to innumerable situations. Further, use of physical objects 140 for enablement/disablement of computing functionality is a dynamic solution, where computing environments can be automatically and situationally adjusted as settings 142 of objects 140 change, as a proximate set of objects change 140, and the like.

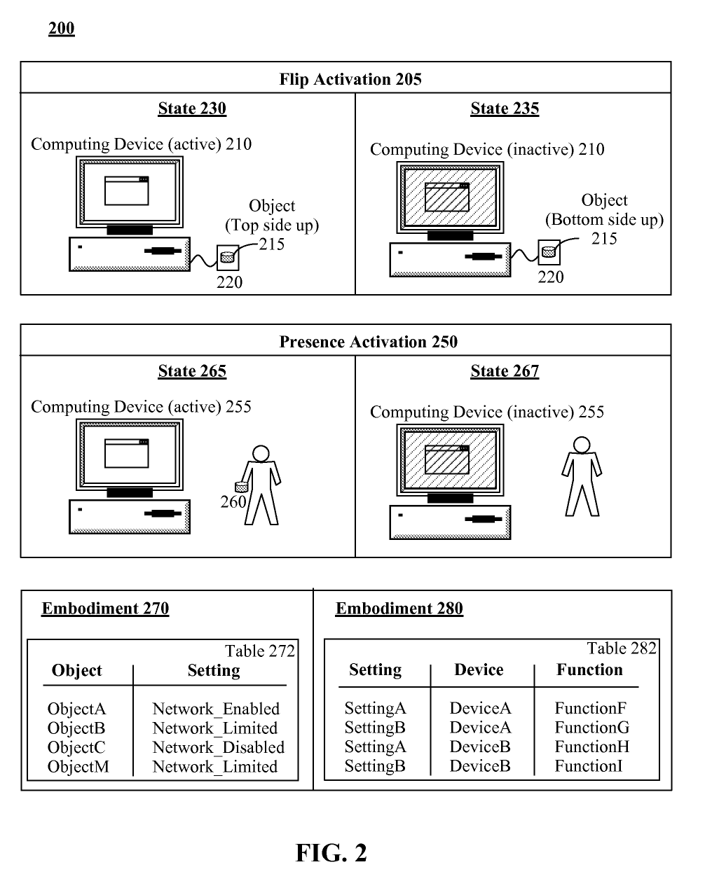

FIG. 2 is a collection 200 of sample embodiments for a physical object that controls an enablement/disablement of a computing device functionality in accordance with an embodiment of the inventive arrangements disclosed herein. The sample embodiments 205, 250, 270, 280 can be performed in context of system 100.

Sample embodiment 205 illustrates a flip activation of the computing device 210 using object 215, which is a two-sided object specifically designed to be placed on a surface of peripheral 220. When a first side of the two-sided object 215 is upward facing, device 210 can be active, as shown be state 230. When the second side is upward facing, the computing device 210 can be inactive, as shown by state 235.

Use of the peripheral 220 is situational depending upon implementation choices. That is, it can be required where the object 215 is only recognized when placed on the peripheral 220 surface; it can be elective where the object is always recognized when proximate to device 210 and/or peripheral 220 while placement of a peripheral 220 surface ensures accuracy, or it can be irrelevant, where placing object 215 on the any surface results in behavior similar to placement on a surface of peripheral 220. The peripheral 220 can optionally “lock” or fix object 215 as well, to prevent object 215 from moving or being lost when “docked” or attached to peripheral 220. The peripheral surface 220 need not be horizontal (e.g., approximately orthogonal to a direction of gravity) but can based upon any arbitrary reference plane, such as relative to a surface of a touch screen of device 210 or a surface of a touch sensitive peripheral 220. It can also be determined based upon a location of one or more transmission, detection source(s) relative to object 215.

The object 215 can be an N-ary object 215 having any number of sides, each associated with an enablement state for a functionality. The object 215 can also be configured using other manual settings, such as switches, knobs, buttons, sliders, and the like. Multiple objects 215 can control an enablement of different device 210 functionality and/or a single object 215 can control multiple functionalities for device 210. Each side can be color-coded, labeled with distinctive graphics, letters, characters, or otherwise marked to permit an observer to discern an enablement state specified by the object 215.

Sample embodiment 250 illustrates a presence activation of the computing device 255. As shown, when object 260 is present, the device 255 can be active, as shown by state 265. When object 260 is absent, the device 255 can be inactive, as shown by state 267. The presence/absence of object 260 need not require a physical coupling between device 255 and object 260, but can be automatically determined whenever object 260 is within a detection range of the device 255. For example, detection can be based upon a scanning and subsequent detection of an RFID tag contained in object 260, can be based upon object 260 entering a wireless transmission range of device 255, and the like. Like embodiment 205, enablement/disablement of functionality for embodiment 250 can be for any number of activation states and for any number of device 255 functionalities. For example, a presence of object 260 can enable a networking functionality and an absence can disable a networking functionality of device 255. In another embodiment, object 260 can include a data store having user identifying information, and a presence of object 260 can enable user specific settings, privileges, while an absence of object 260 can result in a user receiving default or “guest” privileges for the computing device 255

Embodiment 270 shows a table 272 that indicates that multiple objects can be proximate to a given device, and a combination of object settings can determine an enablement state for a functionality. As shown, four objects—ObjectA, ObjectB, ObjectC, and ObjectM, are proximate to device. Each ObjectA-M has an associated network setting. A setting to be applied to the device can depend upon an evaluation algorithm used to interpret a manner in which multiple settings are evaluated. When evaluation is based upon a predominant setting, a network limited functionality can be established, since two of the four Objects A-M have this setting and the remaining two have different settings. If a most-restrictive setting is used, the associated device can be network disabled due to a setting of ObjectC. In one embodiment, a master object (e.g., ObjectM—set to Network_Limited) can establish a maximum privilege level and each other object can be associated with an object specific device. Thus, a device associated with ObjectA (set to Network_Enabled) can be placed in a Network_Limited state, a device associated with ObjectC (set to Network_Disabled) can be placed in a Network_Disabled state; and a device associated with ObjectB (set to Network_Limited) can be placed in a Network_Limited state.

Embodiment 280 shows a table 282 used to demonstrate that states for a single physical object can be configured differently for different devices affected by the physical object. As shown, the controlling object can have two settings—SettingA and SettingB. When adjusted for SettingA, DeviceA can be placed in FunctionalStateF. When adjusted for SettingB, DeviceA can be placed in FunctionalStateG. When object is adjusted for SettingA, DeviceB can be placed in FunctionalStateH. When adjusted for SettingB, DeviceB can be placed in FunctionalStateI. The functional states associated with the various settings and devices can be user and/or administrator configurable, as can the evaluation behavior of embodiment 270.

Configuration adjustments for objects and computing devices can be maintained in any accessible data store or combination of data stores. These data stores can, for example, reside in the physical object itself, in the computing device, in an external data store (e.g., a centralized data store), and/or in a networked data store communicatively linked to the computer device/physical object.

It should be appreciated that in one embodiment, the hardware, software, or firmware of the computing device 210 and 255 or related equipment can be modified to require a use of the object 215, 260. For example, computing device 210 and/or a network router connecting device 210, 255 to a network can be modified so that in absence of an access code associated with the object 215, 260 network functionality is unavailable. The modification requiring object 215 use can be included at manufacturing time, or can be retrofitted through an aftermarket upgrade (e.g., firmware upgrade, software plug-in, etc.). Further, standards can be established for objects 215, 260 and object enablements so that any computing device 210 conforming to the standard can be utilized in conjunction with the objects 215, 260 as described herein.

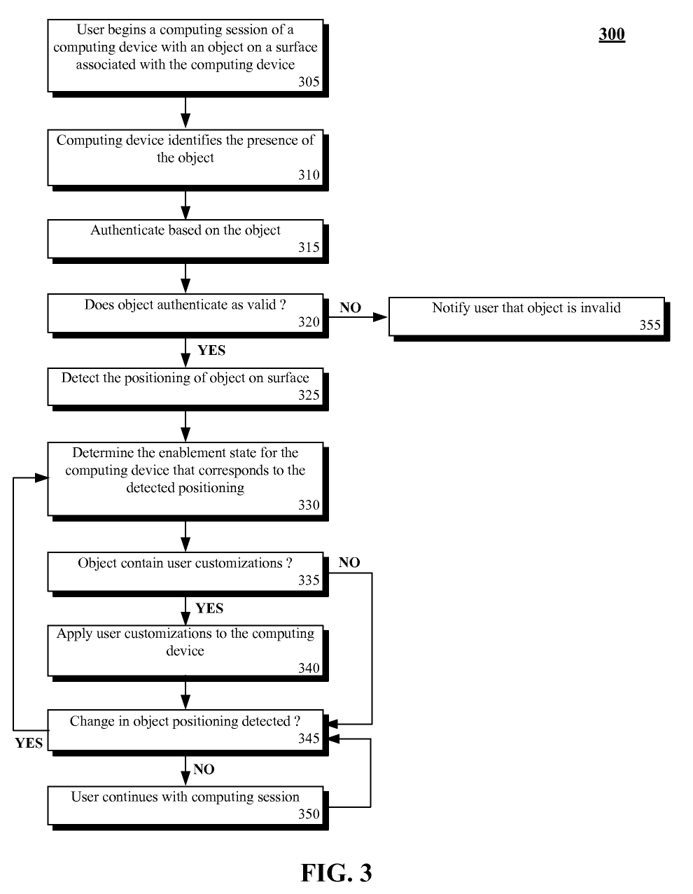

FIG. 3 is a flow chart of a method 300 detailing the use of a physical object to control an enablement state of a computing device in accordance with an embodiment of the inventive arrangements disclosed herein. Method 300 can be performed in the context of system 100. Method 300 is directed towards a physical object having different adjustable positions (settings), each associated with a different functional setting. Authentication for use of a computing device is also performed based upon a presence of a suitable physical object. These are situation specific uses for the physical object and are not to be construed as a limitation of the invention in general.

Method 300 can begin with step 305 where a user can begin a computing session of a computing device with a physical object on a surface associated with the computing device. The computing device can identify the presence of the object in step 310. Authentication of the object can occur in step 315.

The validity of the object authentication can be determined in step 320. When the object is determined to be invalid, flow can proceed to step 355 where the user can be notified of the object's invalidity. When the object is determined to be valid, step 325 can execute where the positioning of the object on the surface can be detected.

The enablement state that corresponds to the detected positioning can be determined for the computing device in step 330. In step 335, it can be determined if the object (e.g., a data store of the object or a data store of a computing device associated with a unique object key) contains user customizations. When user customizations are present, step 340 can execute where the user customizations can be applied to the computing device.

After the application of user customizations or when user customizations are not present, step 345 can execute where it can be determined if a change in the object positioning is detected. If a change in object positioning is detected, flow can return to step 330 where the subsequent steps of method 300 can continue to execute. If no change is detected, the user can continue with their computing session in step 350. From step 350, flow can return to step 345, executing through 350 until the computing session is complete.

The diagrams in FIGS. 1-3 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for controlling the enablement state of a functionality of a computing device comprising:
identifying at least one N-sided physical object, wherein each side of said N-sided physical object is associated with at least one enablement state for a functionality of a computing device, wherein an indicator of this associated enablement state is visibly present on each side of the N-sided physical object;
sensing which of said N-sides is facing a reference plane; and
programmatically changing an enablement state of a functionality of at least one computing device to correspond to an enablement state indicated by the N-sided physical object.

2. The method of claim 1, wherein said N-sided physical object is not directly electronically coupled to said computing device, wherein said computing devices detects a proximity of said at least one N-sided physical object using wirelessly exchanged digital information via a personal area network within which said N-sided physical object and said computing device are both nodes.

3. The method of claim 1, wherein said N-sided physical object is not directly electronically coupled to said computing device, wherein said computing devices detects a proximity of said at least one N-sided physical object by scanning at least one radio frequency identification (RFID) tag embedded within the N-sided physical object.

4. The method of claim 1, wherein said functionality is a network functionality of the computing device, and wherein said enablement state determines whether a level of the network functionality authorized for a user of the computing device.

5. A method of claim 1, further comprising:
customizing the N-sided physical object for at least one user preference, wherein customized user preference is associated with at least one application residing on the computing device, wherein the programmatic changing of the enablement state changes an enablement of said at least one application based upon said at least one user preference.

6. A computing device comprising:
an object detector configured to detect a presence and a position of at least one physical object proximate to a computing device, wherein different positions of the physical object corresponds to different enablement states for at least one functionality of the computing device; and
an enablement engine configured to control an enablement state of the at least one functionality of the computing device, wherein said enablement state comprises at least an active state and an inactive state, wherein said enablement engine is configured to detect a change in positioning of the at least one physical object, and is configured to perform programmatic actions to modify the enablement state of said at least one functionality to correspond to an enablement state indicated by the change in positioning of the at least one physical object.

7. The computing device of claim 6, wherein said computing device is configured to be not directly electronically coupled to the physical object.

8. The computing device of claim 7, wherein said computing device is configured to be communicatively linked to the physical object through at least one wireless transceiver.

9. The computing device of claim 7, further comprising:
at least one radio frequency identification (RFID) scanner configured to interact with at least one radio frequency identification (RFID) tag embedded within the physical object.

10. The computing device of claim 6, further comprising:
a configuration adjustor configured to permit an authorized user to adjust settings of the enablement engine, which change the programmatic actions performed responsive to a change in the positioning of the at least one physical object.

11. The computing device of claim 6, further comprising:
a peripheral configured to be communicatively linked to said computing device, wherein said peripheral is configured to detect a presence and a position of the at least one physical object, wherein said peripheral is configured such that the at least one physical object is to be placed in direct contact of a surface of the peripheral.

12. The computing device of claim 6, said at least one physical object comprises a plurality of physical objects, wherein said enablement engine is configured to determine an enablement state of said at least one functionality based upon said positioning of said plurality of physical objects in accordance with an algorithm that utilizes user configured settings in its determination.

13. The computing device of claim 6, wherein each of said at least one physical object is an n-sided object, and wherein each side of the n-sided object corresponds to a position, which corresponds to an enablement state for said at least one functionality, wherein said object detector is configured to determine which one of the sides of the n-sided object faces a reference plane.

14. The computing device of claim 13, wherein said at least one physical objects comprise a plurality of physical objects, wherein said at least one functionality comprises a plurality of functionalities, wherein a one-to-one correspondence exists between physical objects and functionalities.

15. A physical object for controlling an enablement state of a computing device comprising: at least one unique characteristic that is configured to be detected by a computing device not directly electronically coupled to the physical object when the physical token is placed on a surface proximate to the computing device, wherein a positioning of the physical token relative to the surface corresponds to different enablement states for at least one functionality of the computing device, wherein the different enablement states comprise at least an active state and an inactive state.

16. The physical object of claim 15, wherein said physical object is an N-sided object, wherein each side corresponds to an enablement state, wherein the N-sided object is configured to permit a user to reposition the N-sided object so that different ones of the sides of the N-sided object are against the surface.

17. The physical object of claim 15, wherein said physical object is an N-sided object, wherein each side corresponds to an enablement state, wherein each side of the N-sided object is labeled to permit an observer to visually identify an enablement state indicated by the N-sided object.

18. The physical object of claim 15, wherein the physical object is a security artifact, which must be placed upon the surface before a user is able to access functionality of the computing device, wherein the physical token comprises at least one radio frequency identification (RFID) tag that contains a security key.

19. The physical object of claim 15, further comprising:
a data store comprising digitally encoded information used by the computing device for programmatic actions relating to the enablement state of the related functionality; and
a wireless transceiver configured to wireless convey information between the data store and the computing device.

20. The physical object of claim 19, wherein said physical object is an N-sided object, wherein each side corresponds to an enablement state, said physical object further comprising:
at least one sensor configured to determine which of the sides of the N-sided object is against said surface, wherein said wireless transceiver is configured to convey data relating to the sensor determination of the surface facing side to the computing device.
